(19) United States
(12) Patent Application Publication
(10) Pub. No.: US 2002/0102866 A1
(43) Pub. Date: Aug. 1, 2002

(54) Electronic apparatus comprising two mutually movable parts

(76) Inventor: Jean-Pierre Lubowicki, Le Mans (FR)

Correspondence Address: Jack D. Slobod, c/o U.S. PHILIPS CORPORATION, Intellectual Property Department, 580 White Plains Road, Tarrytown, NY, 10591, US

(21) Appl. No.: 10/028,387

(22) Filed: Dec. 21, 2001

(30) Foreign Application Priority Data
Dec. 28, 2000 (FR) 0017204

(51) Int. Cl. H01R 39/00

(52) U.S. Cl. 439/1

(57) ABSTRACT

The invention proposes an electronic apparatus which comprises two parts (12, 14) which are mutually movable and can be electrically interconnected, so that at least one of them transmits information to the other so as to control functions of the electronic apparatus.

The two parts (12, 14) are mounted mutually sliding between a retracted position, in which the electronic apparatus permits to carry out the first group of functions, and an open position, in which the electronic apparatus permits to carry out a second group of functions.

The invention relates to an electronic apparatus which comprises two mutually movable parts.

The invention more particularly relates to an electronic apparatus comprising two parts which are mutually movable and can be electrically interconnected so that at least one of them transmits data to the other so as to control functions of the electronic apparatus.

The design of electronic apparatuses, notably mobile GSM telephones, is influenced, on the one hand, by the miniaturization of the apparatus and, on the other hand, by the increase of the number of functions and by the improvement of the user interfaces so as to facilitate their use and permit a simple, ergonomic and pleasant control of the functions.

Thus there are small-size electronic apparatuses which permit to carry out a certain number of functions and which comprise user interfaces such as a keypad and a screen having reduced dimensions. There are also larger apparatuses which permit to carry out a larger number of functions and which comprise, for example, a screen having larger dimensions, which notably permits a more pleasant use of the apparatus and a display of more data.

Thus in a general way the dimensions of the apparatus as well as the functions that can be carried out are predetermined.

U.S. Pat. No. 5,303,291 proposes and represents a mobile telephone which comprises a movable cover in which a functional module is mounted such as a calculator or an electronic clock.

The function module can be detached and replaced by another module which permits to carry out different functions. It is arranged pivotable on the housing of the telephone between a closed position, in which it covers the keypad of the apparatus so as to protect it, and an open position, in which it permits access and activation of the keys by the user of the telephone.

When the function module is in closed position, the telephone has reduced dimensions. However, the use of the telephone is not possible, since the keypad is covered by the function module thus preventing taking the line and dialing.

To solve these problems, the invention proposes an electronic apparatus which comprises two parts which are mutually movable and can be interconnected, so that at least one of them transmits data to the other to control functions of the electronic apparatus, this apparatus being characterized in that the two parts are mounted mutually slidable between a retracted position, in which the electronic apparatus permits to carry out a first group of functions, and an open position in which the electronic apparatus permits to carry out a second group of functions.

According to other characteristics of the invention:

the two parts can be separated from each other and, after separation, at least one of them permits to carry out a third group of functions in an autonomous way;

one of the two parts forms a body which permits to carry out a group of basic functions and the other part is in the form of a separable function module, which permits to realize a range of apparatuses based on the same body;

the sliding from one position to another permits to control the activation or deactivation of at least one function of the electronic apparatus;

the electronic apparatus comprises a telephone, notably a mobile GSM telephone, and a first part comprises a keypad and constitutes a body with respect to which the second part, which comprises a display screen, is mounted slidable;

in retracted position a first portion of the display screen which is accessible through an opening of the body permits to display data such as a telephone number and in open position a second portion of the screen, previously masked by the body, permits to display additional data such as pictograms or text parts;

when the two parts are separated, the second part constitutes an autonomous electronic device such as a memory aid or an organizer.

These and other aspects of the invention are apparent from and will be elucidated, by way of non-limitative example, with reference to the embodiment(s) described hereinafter.

In the drawings:

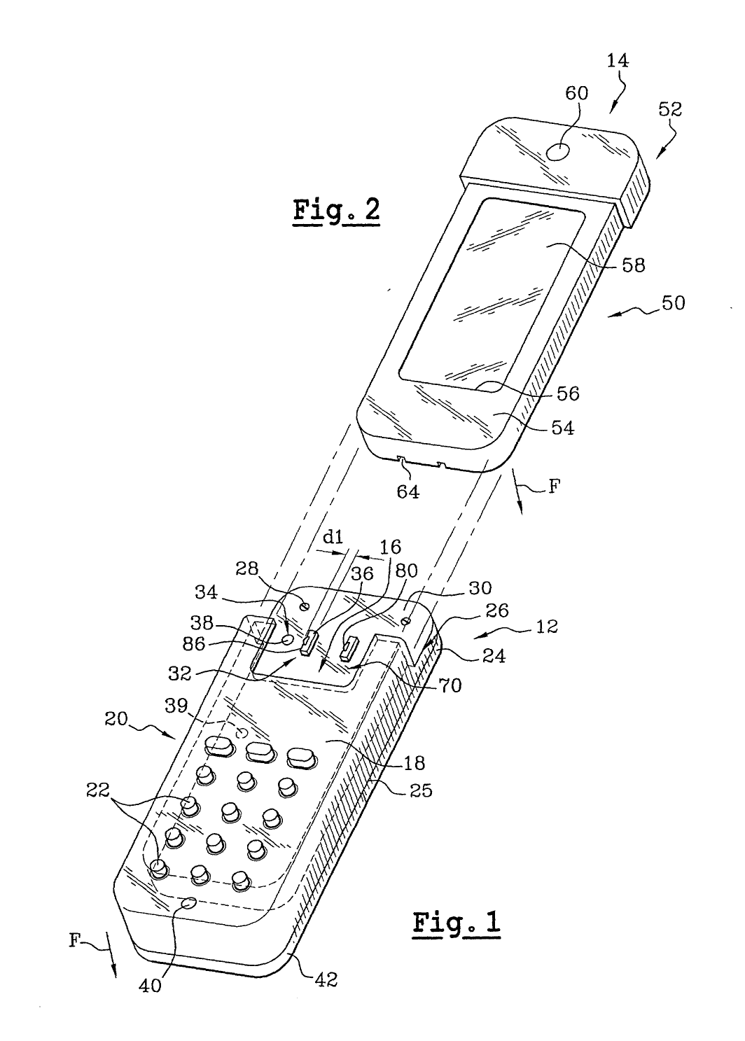

FIG. 1 shows in a perspective view a first part forming the body of a mobile telephone made according to the invention;

FIG. 2 shows in a perspective view a second part of the mobile telephone made according to the invention;

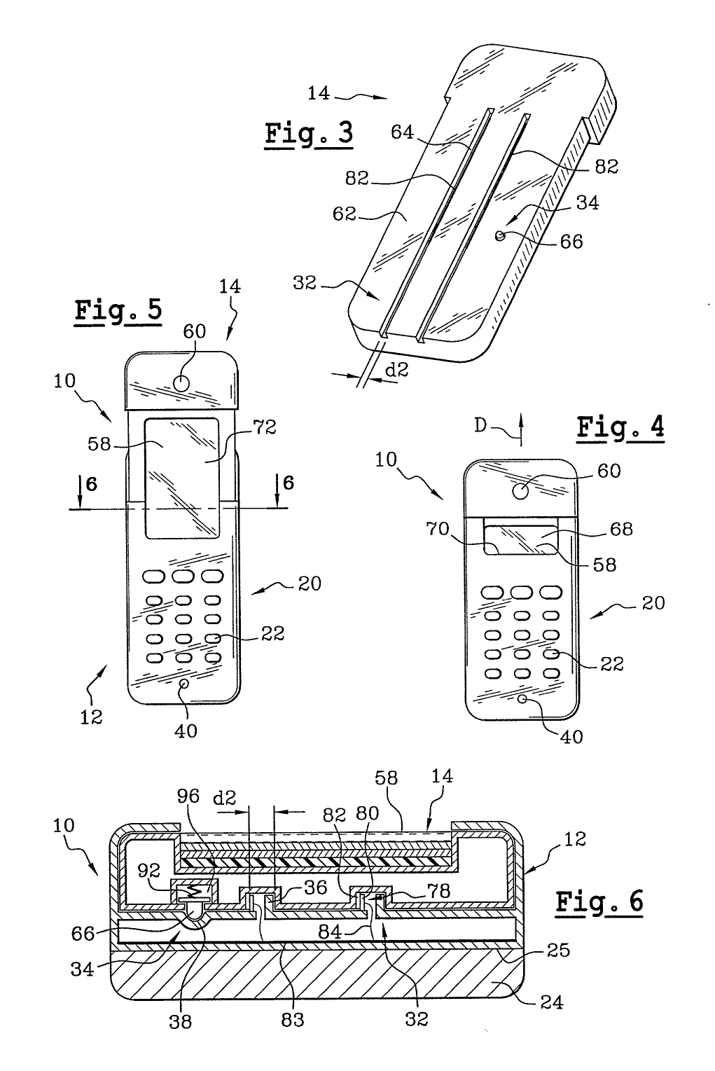

FIG. 3 shows in a perspective view seen from below the second part of the mobile telephone shown in FIG. 2;

FIG. 4 diagrammatically shows a mobile telephone made according to the invention with the second part in retracted position;

FIG. 5 diagrammatically shows a mobile telephone realized according to the invention with the second part in open position;

FIG. 6 is a partial cross-section of the mobile telephone along the line 6-6 shown in FIG. 5;

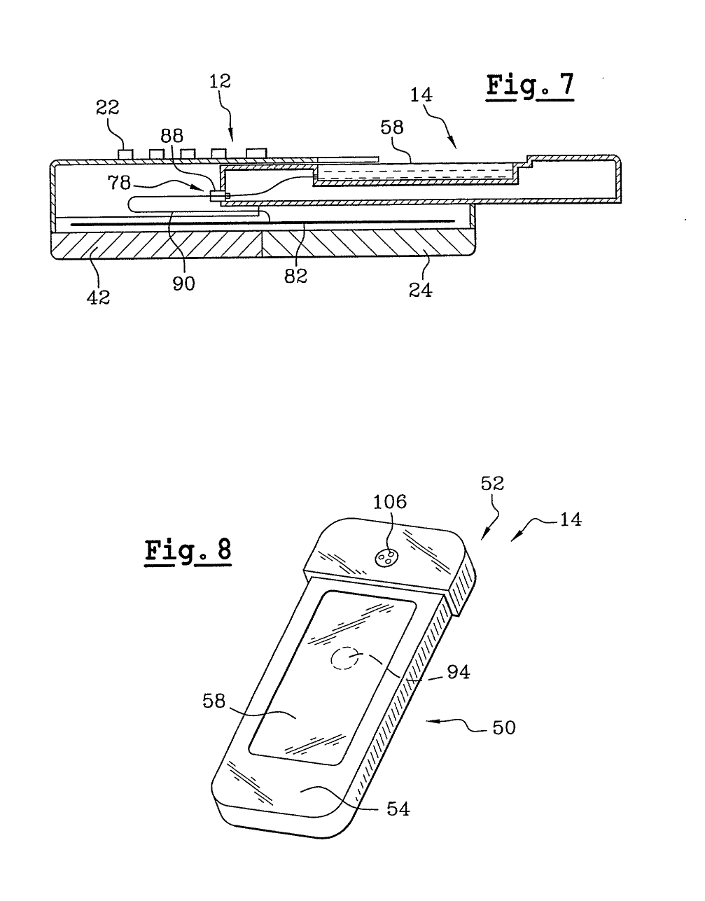

FIG. 7 diagrammatically shows a longitudinal section of the mobile telephone according to a variant of embodiment of the invention;

FIG. 8 shows in a perspective view a second modular part of the mobile telephone according to a variant of embodiment of the invention.

In the following of the description the electronic apparatus is in a non-limiting manner a mobile telephone, notably a GSM or GPRS telephone.

The FIGS. 1 and 2 show in a perspective view a first part 12 which constitutes a body and a second part 14, which can be assembled to form a mobile telephone 10 which is represented in FIGS. 4 and 5.

In the following of the description a top-to-bottom orientation will be used in accordance with the direction from high to low of the arrow F represented in FIGS. 1 and 2.

The first part 12 constitutes the body of the telephone 10. It is in the form of side walls which mark off the boundary of parallelepipedonal housing 16.

The front upper side wall 18 or main side wall comprises a keypad 20 formed by keys 22 spread over five horizontal rows of three keys each.

Each key 22 is movable between a position of rest and an actuation position in which it can co-operate with a trigger element of an associated electric switch, which is not shown.

When a key 22 is in an actuation position, the electric state of an associated electric control circuit is modified so as to control at least one function of the telephone 10.

The first part 12 comprises a transmission device 24 in this case, which transmission device 24 permits to receive and transmit data, that is to say, communicate with a similar device.

The transmission device 24 can be connected to the lower surface 25 of the rear side wall 26 and be fixed by screws 28 of which two are shown in FIG. 1.

The upper face 30 of the rear side wall 26 comprises transfer guide means 32 and stop means 34 at the position of the second part 14 relative to the first part 12.

The guide means 32 consist of two ribs 36 in this case, which ribs are parallel to each other and are facing in the main longitudinal direction of the first part 12. The ribs 36 can co-operate with recessed forms such as the recesses 64 realized in the second part 14.

The stop means 34 comprise cavities 38 and 39 in this case, which cavities can co-operate with a retractable lug of the second part 14 when the first and second parts 12 and 14 are joined together.

The first part also comprises a microphone whose orifice 40 permits to facilitate the emission of the user's voice to the microphone.

The first part 10 further comprises a set of accumulators 42 which is fixed to the lower face of the rear wall 26.

The set of accumulators 42 notably permits to supply electric power to a printed circuit board of the first part 12, which comprises electronic circuits which permit to manage control data notably coming from the keypad 20 with keys 22, from the transmission device 24 and from the second part 14 when it is joined to the first part 12.

The second part 14 comprises a first portion 50 in a form of a parallelepiped complementary to the housing 16, and a second portion 52 which constitutes a free end of the telephone 10.

The form of the second portion 52 is defined so as to have a nice looking telephone 10.

The upper face 54 of the second part 14 has a window 56 which is passed through by a display screen 58 such as a liquid crystal display screen, which is rectangular in this case.

The display screen 58, also called screen, permits to show data which may vary very much, such as figures, letters, pictograms, drawings or images for display by the user of the telephone 10.

The display screen 58 is controlled by electric control circuits which notably comprise control circuits associated to the keys 22.

The display screen 58 may also be a touch-sensitive device, that is to say, that it can be controlled by the user's finger pressing a defined area of the screen.

The second part 14 comprises a sound emitting device (not shown) of which an orifice 60, which is situated on the upper face 54 of the second portion 52, permits to facilitate the emission of sound to the user's ear.

FIG. 3 represents the second part 14 in a perspective view seen from below. It comprises on its lower surface 62 the guide means 32 for longitudinal movement, which guide means 32 are complementary to the ribs 36. The guide means 32 consist of two parallel grooves 64.

The lower surface 62 also carries the stop means 34 which comprise a retractable lug 66 which can fit in the cavities 38 and 39 when the two parts 12 and 14 are joined together.

According to the invention the two parts 12 and 14 can be joined together and mounted mutually sliding between a retracted and an open position represented in the FIGS. 4 and 5, respectively.

FIG. 4 diagrammatically shows the telephone 10 formed by the two parts 12 and 14 in retracted position. In this position a first portion 68 of the display screen 58 is accessible through an opening 70 of the first part 12 so as to permit the display of data shown on the first portion of the screen 58. In retracted position the telephone 10 permits to carry out a first group of functions.

The first group of functions notably consists of dialing a telephone number by touching the keys 22 of the keypad 20, the display of the dialed telephone number on the first portion 68 of the display screen 58, the set-up of a communication with another telephone, etc.

Thus, in retracted position the telephone 10 is compact, it has a small-size front surface.

In open position, represented in FIG. 5, a second portion 72 of the display screen 58, which is masked by the upper front wall 18 in retracted position, is accessible.

When the telephone 10 is in open position, the user can display data shown on the first portion 68 and second portion 72 of the screen 58. Thus it is possible to display additional data relating to the displayed data in retracted position, such as pictograms or text parts.

The telephone 10 in open position permits to carry out a second group of functions which in this case corresponds to the first group to which new functions are added, such as the communication of the telephone 10 with the Internet and the display of additional data, for example, pictograms or text parts.

The open position permits access to a considerable portion of the screen 58, which permits the display of a quantity of important data, which data can be presented in various forms such as letters, figures, symbols or pictograms, which facilitates the use of the telephone 10.

The ease of use of the visual interface, here the screen 58, is thus improved.

Moreover, if the display screen 58 is of the touch-sensitive type, it permits to simplify and render the control of certain functions more pleasant by the touch of the user's finger on certain areas.

Thus, in open position the telephone has a front face of larger dimensions than when the telephone 10 is in retracted position. It thus permits the display of more data, which augments the potential of the telephone 10 and its ease of use.

It is thus possible to propose a plurality of functions to the user such as games, an access to the Internet or WAP system network the possibility of receiving, displaying and transmitting images.

For communication between them, the first part 12 and the second part 14 are electrically connected when they are joined together.

FIG. 6 represents on an enlarged scale a cross-section of the telephone 10. FIG. 6 notably shows an electrical connection 78 between the two parts 12 and 14.

The electrical connection 78 is achieved via the contact of two conductive plates 80 of the first part 12, with two complementary tracks 82 of the second part 14.

The conductive plates 80 are connected to the printed circuit board 83 of the first part 12 via conductive wires or tracks 84.

Similarly, the complementary tracks 82 are connected to the display screen 58.

By way of example, the electrical connection 78 is arranged in the guide means 32.

The plates 80 are each arranged in a side face 86 (represented in FIG. 1) of a rib 36. The plates 80 are bulging transversely.

The plates 80 are elastic and when the two parts 12 and 14 are not joined together, their top protrudes transversely beyond corresponding side faces 86. Thus the distance d1 represented in FIG. 1, which the top of a plate 80 and the opposite side face of the corresponding rib 36 are apart, is larger than the width d2 (represented in FIGS. 3 and 6) of the groove 64 with which the rib 36 engages.

Thus, in accordance with FIG. 6, the plate 80 of each rib 36 is in contact with the associated track 82.

The elastic properties of the plate 80 permit to suppress the transversal play which there is between the groove 64 and the associated rib 36, which optimizes the transversal guiding of the parts 12 and 14 with respect to each other and permits to ensure a permanent contact between the plate 80 and the associated track 82.

The electrical connection 78 may comprise, on the same side face of a rib 36, various tracks 80 having vertically shifted reduced height and which operate each with an associated conductive track 82. It is also possible to arrange various plates 80 on each of the side faces 86 of the ribs 36 to achieve more electrical connections between the first part 12 and the second part 14.

According to a variant, the plate 80 may extend to the upper face of a rib 36, the corresponding track 82 being then fixed to the surface opposite the corresponding groove 64.

According to another variant, represented in FIG. 7, the electrical connection 78 may be realized by a connector 88 which is connected to the printed circuit board 83 via a layer of flexible conductors 90. Thus, when the second part 14 is slid into the body 12, the layer of flexible conductors 90 is deformed to follow the movement of the connector 88.

FIG. 6 also represents in a cross-section the stop means 34 which permit to keep the telephone 10 in open position.

As a mater of fact, the stop means 34 notably comprise a cavity 38 which co-operates with a retractable lug 66 in open position, so as to immobilize the sliding of the first part 12 relative to the second part 14.

The retractable lug 66 is permanently returned to an outward position represented in FIG. 6 by an elastic element 92 such as a spring.

When the telephone 10 is in retracted position, the retractable lug 66 fits in the cavity 39 represented in FIG. 1.

To provoke the sliding of the second part 14 to the open position, the user is to exert a given longitudinal traction force in the direction D represented in FIG. 4. The longitudinal traction force is to be sufficient to cause the lug 66 to be retracted in its housing 96. Then, less force suffices for making the second part 14 slide in a first part 12 until the telephone 10 is in open position in accordance with FIGS. 5 and 6 and until the lug 66 fits in the cavity 38.

The sliding from the retracted position to the open position may permit to control a function such as taking a call or activating the lighting of the display screen 58.

Similarly, the sliding from the open position to the retracted position may permit to cut off the call or turn off the lighting of the screen 58.

According to the invention the first 12 and second 14 parts can be separated. To achieve this, when the telephone 10 is in an open position, the user is to exert the given longitudinal traction force to cause the lug 66 to be retracted. The sliding then permits to separate the two parts 12 and 14.

According to the invention the second part 14 permits to form a third group of functions in an autonomous way after the separation. Thus the second part 14 comprises a printed circuit board which permits to manage control data to carry out the functions of the third group.

For example, the second part 14 can constitute an autonomous electronic device, such as a memory aid or an organizer.

In this case the second part 14 is to comprise a set of accumulators, which are not shown, which may be recharged by the set of accumulators 42 of the first part 12 when the two parts 12 and 14 are joined together.

The set of accumulators of the second part 14 may also be a set of accumulators of the first part 12 in joined position.

The control of the organizer functions may be realized via the screen itself if the screen is a touch-sensitive screen, or via keys (not shown) which are advantageously arranged in the upper face 54.

The invention also proposes that the telephone 10 is modular, that is to say, that the first part 12 constitutes a body which permits to carry out a basic group of functions such as dialing the telephone numbers with the keys 22 of the keypad 20 or the call with a similar device, and the second part 14 constitutes a function module which can be separated, which permits to realize a range of devices based on the same body 12.

Thus it is possible to join different second parts 14 together with a single first part 12.

For example, the second part 14 represented in FIG. 2 can comprise a display screen 58 in black and white, it can also comprise a color screen 58.

According to FIG. 8 the second part 14 may further comprise a video device 94 such as a video camera, photovoltaic cells and a sound amplifying device 106 which permits to realize a hands-free telephone 10.

The invention permits to easily modify certain characteristics of the telephone 10 such as the number of its functions or its external appearance. Actually, joining together the parts 12 and 14 and separating them does not require any particular tool.

The modularity of the telephone 10, which permits to create a range of apparatuses, may be effected in the factory. In this case a single body 10 can be used for various second modular parts 14 so as to propose various models which have esthetic and functionally different characteristics. This permits to reduce the cost of manufacture.

The modularity of the telephone 10 may also be realized by the user. After having bought a body 12 and chosen a second part 14, he can then buy solely a second modular part 14 to make the characteristics of his telephone 10 evolve, according to the evolution of his desires and his needs.

The preceding description is not limiting. Actually, it is possible, without leaving the scope of the invention, to realize mechanical inversions such as an inversion between the ribs 36 and the grooves 64 of the guide means or to use equivalents.

Moreover, it is possible for the first part 12 also to be modular so as to augment the number of possible combinations and enlarge the range of telephones 10.

1. An electronic apparatus which comprises two mutually movable parts (12, 14) which can be electrically interconnected so that at least one of them transmits data to the other so as to control functions of the electronic apparatus, this apparatus being characterized in that the two parts (12, 14) are mounted mutually slidable between a retracted position, in which the electronic apparatus permits to carry out a first group of functions, and an open position in which the electronic apparatus permits to carry out a second group of functions.

2. An electronic apparatus as claimed in claim 1, characterized in that the two parts (12, 14) can be separated from each other and in that, after separation, at least one of them permits to carry out a third group of functions in an autonomous way.

3. An electronic apparatus as claimed in claim 2, characterized in that one of the two parts (12, 14) forms a body which permits to carry out a group of basic functions and in that the other part is in the form of a separable function module, which permits to realize a range of apparatuses based on the same body.

4. An electronic apparatus as claimed in any one of the preceding claims, characterized in that the sliding from one position to another permits to control the activation or deactivation of at least one function of the electronic apparatus.

5. An electronic apparatus as claimed in any one of the preceding claims, characterized in that it comprises a telephone (10), notably a mobile GSM or GPRS telephone, and in that a first part (12) comprises a keypad (20) with keys (22) and constitutes a body with respect to which the second part (14), which comprises a display screen (58), is mounted slidable.

6. An electronic apparatus as claimed in claim 5, characterized in that in retracted position a first portion (68) of the display screen (58) which is accessible through an opening (70) of the body (12) permits to display data such as a telephone number, and in that in an open position a second portion (72) of the screen, previously masked by the body (12), permits to display additional data such as pictograms or text parts.

7. An electronic apparatus as claimed in one of the claims 5 or 6, characterized in that, when the two parts (12, 14) are separated, the second part (14) constitutes an autonomous electronic device such as a memory aid or an organizer.
